(19) United States
(12) Patent Application Publication
(10) Pub. No.: US 2025/0024324 A1
(43) Pub. Date: Jan. 16, 2025

(54) CHANNEL FEATURE INFORMATION TRANSMISSION METHOD AND APPARATUS, TERMINAL, AND NETWORK SIDE DEVICE

(71) Applicant: VIVO MOBILE COMMUNICATION CO., LTD., Guangdong (CN)

(72) Inventors: Qianyao REN, Guangdong (CN); Tian XIE, Guangdong (CN)

(73) Assignee: VIVO MOBILE COMMUNICATION CO., LTD., Guangdong (CN)

(21) Appl. No.: 18/903,516

(22) Filed: Oct. 1, 2024

Related U.S. Application Data
(63) Continuation of application No. PCT/CN2023/085012, filed on Mar. 30, 2023.

(30) Foreign Application Priority Data
Apr. 1, 2022 (CN) 202210349419.2

(51) Int. Cl. H04W 28/06; H04L 25/02; H04W 24/10

(52) U.S. Cl. CPC H04W 28/06; H04L 25/0254; H04W 24/10

(57) ABSTRACT

A channel feature information transmission method and apparatus, a terminal, and a network side device. The channel feature information transmission method in the embodiments of this application includes: inputting, by a terminal, channel information of each layer into a corresponding first artificial intelligence AI network model for processing, and obtaining channel feature information output by the first AI network model, where one layer corresponds to one first AI network model; and reporting, by the terminal, the channel feature information corresponding to each layer to a network side device.

### CROSS-REFERENCE TO RELATED APPLICATIONS

This application is a continuation of International Application No. PCT/CN2023/085012 filed on Mar. 30, 2023, which claims priority to Chinese Patent No. 202210349419.2 filed on Apr. 1, 2022, which are incorporated herein by reference in their entireties.

### TECHNICAL FIELD

This application pertains to the field of communication technologies, and in particular, to a channel feature information transmission method and apparatus, a terminal, and a network side device.

### BACKGROUND

With the development of science and technology, people have started to study application of an artificial intelligence (AI) network model in a communication system. For example, communication data may be transmitted between a network side device and a terminal based on the AI network model. Currently, in a channel information compression feedback solution based on the AI network model, channel information is compressed and encoded on a terminal, and compressed content is decoded on a network side to restore the channel information is restored. In this case, a decoding network on the network side and an encoding network on a terminal side need to be jointly trained to achieve a proper degree of matching. In a related technology, channel information of different quantities of layers needs to be compressed and encoded by using different AI network models, and therefore, a plurality of AI network models need to be trained to process the channel information. Consequently, power consumption on the terminal side and the network side also increases accordingly.

### SUMMARY

Embodiments of this application provide a channel feature information transmission method and apparatus, a terminal, and a network side device.

According to a first aspect, a channel feature information transmission method is provided, and includes:
inputting, by a terminal, channel information of each layer into a corresponding first artificial intelligence AI network model for processing, and obtaining channel feature information output by the first AI network model, where one layer corresponds to one first AI network model; and
reporting, by the terminal, the channel feature information corresponding to each layer to a network side device.

According to a second aspect, a channel feature information transmission method is provided, and includes:
receiving, by a network side device, channel feature information corresponding to each layer that is reported by a terminal; where
one layer of the terminal corresponds to one first AI network model, and the first AI network model is used to process channel information of a layer that is input by the terminal and output the channel feature information.

According to a third aspect, a channel feature information transmission apparatus is provided, and includes:
a processing module, configured to: input channel information of each layer into a corresponding first AI network model for processing, and obtain channel feature information output by the first AI network model, where one layer corresponds to one first AI network model; and
a reporting module, configured to report the channel feature information corresponding to each layer to a network side device.

According to a fourth aspect, a channel feature information transmission apparatus is provided, and includes:
a receiving module, configured to receive channel feature information corresponding to each layer that is reported by a terminal; where
one layer of the terminal corresponds to one first AI network model, and the first AI network model is used to process channel information of a layer that is input by the terminal and output the channel feature information.

According to a fifth aspect, a terminal is provided, where the terminal includes a processor and a memory, the memory stores a program or an instruction that can be run on the processor, and when the program or the instruction is executed by the processor, the steps of the channel feature information transmission method according to the first aspect are implemented.

According to a sixth aspect, a terminal is provided, including a processor and a communication interface. The processor is configured to: input channel information of each layer into a corresponding first artificial intelligence AI network model for processing, and obtain channel feature information output by the first AI network model, where one layer corresponds to one first AI network model. The communication interface is configured to report the channel feature information corresponding to each layer to a network side device.

According to a seventh aspect, a network side device is provided, where the network side device includes a processor and a memory, the memory stores a program or an instruction that can be run on the processor, and when the program or the instruction is executed by the processor, the steps of the channel feature information transmission method according to the second aspect are implemented.

According to an eighth aspect, a network side device is provided, including a processor and a communication interface. The communication interface is configured to receive channel feature information corresponding to each layer that is reported by a terminal, where one layer of the terminal corresponds to one first AI network model, and the first AI network model is used to process channel information of a layer that is input by the terminal and output the channel feature information.

According to a ninth aspect, a communication system is provided, including a terminal and a network side device, where the terminal may be configured to perform the steps of the channel feature information transmission method according to the first aspect, and the network side device may be configured to perform the steps of the channel feature information transmission method according to the second aspect.

According to a tenth aspect, a readable storage medium is provided, where the readable storage medium stores a program or an instruction, and when the program or the instruction is executed by a processor, the steps of the channel feature information transmission method according to the first aspect are implemented, or the steps of the channel feature information transmission method according to the second aspect are implemented.

According to an eleventh aspect, a chip is provided. The chip includes a processor and a communication interface, the communication interface is coupled to the processor, and the processor is configured to run a program or an instruction to implement the channel feature information transmission method according to the first aspect or the channel feature information transmission method according to the second aspect.

According to a twelfth aspect, a computer program product/program product is provided. The computer program product/program product is stored in a storage medium, and the computer program/program product is executed by at least one processor to implement the steps of the channel feature information transmission method according to the first aspect or the steps of the channel feature information transmission method according to the second aspect.

### BRIEF DESCRIPTION OF DRAWINGS

FIG. 1 is a block diagram of a wireless communication system to which the embodiments of this application are applicable;

FIG. 2 is a flowchart of a channel feature information transmission method according to an embodiment of this application;

FIG. 3 is a flowchart of another channel feature information transmission method according to an embodiment of this application;

FIG. 4 is a structural diagram of a channel feature information transmission method apparatus according to an embodiment of this application;

FIG. 5 is a structural diagram of another channel feature information transmission method according to an embodiment of this application;

FIG. 6 is a structural diagram of a communication device according to an embodiment of this application;

FIG. 7 is a structural diagram of a terminal according to an embodiment of this application; and

FIG. 8 is a structural diagram of a network side device according to an embodiment of this application.

### DETAILED DESCRIPTION

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing a specific order or sequence. It should be understood that, the terms used in such a way are interchangeable in proper circumstances, so that the embodiments of this application can be implemented in an order other than the order illustrated or described herein. Objects classified by “first” and “second” are usually of a same type, and a quantity of objects is not limited. For example, there may be one or more first objects. In addition, in the description and the claims, “and/or” represents at least one of connected objects, and a character “/” generally represents an “or” relationship between associated objects.

It should be noted that technologies described in the embodiments of this application are not limited to a Long Term Evolution (LTE)/LTE-Advanced (LTE-A) system, and may further be applied to other wireless communication systems such as Code Division Multiple Access (CDMA), Time Division Multiple Access (TDMA), Frequency Division Multiple Access (FDMA), Orthogonal Frequency Division Multiple Access (OFDMA), single-carrier frequency division multiple access (SC-FDMA), and other systems. The terms “system” and “network” in the embodiments of this application may be used interchangeably. The technologies described can be applied to both the systems and the radio technologies mentioned above as well as to other systems and radio technologies. A new radio (NR) system is described in the following description for illustrative purposes, and the term NR is used in most of the following description, although these technologies can also be applied to applications other than the NR system application, such as a 6^{th} generation (6G) communication system.

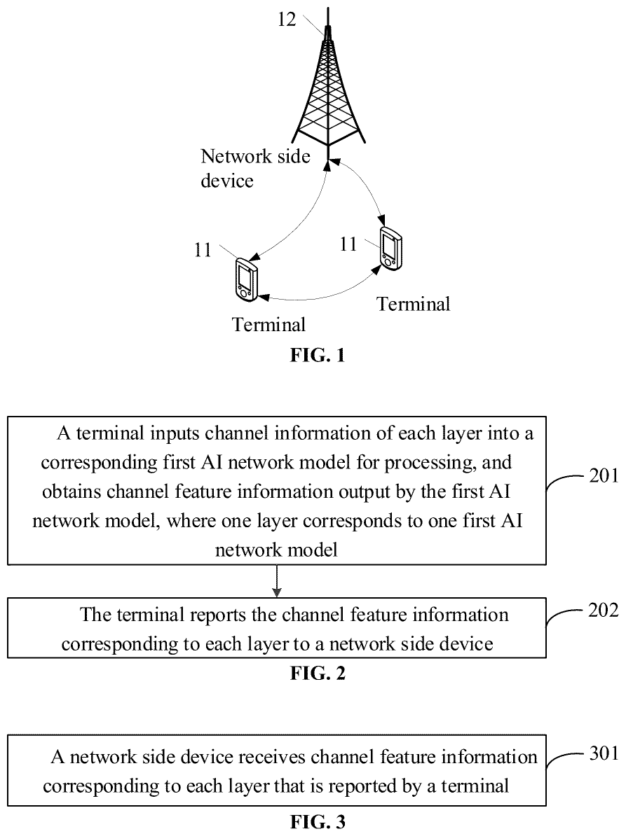

FIG. 1 is a block diagram of a wireless communication system to which the embodiments of this application are applicable. The wireless communication system includes a terminal 11 and a network side device 12. The terminal 11 may be a terminal side device such as a mobile phone, a tablet personal computer, a laptop computer that is also referred to as a notebook computer, a personal digital assistant (PDA), a palmtop computer, a netbook, an ultra-mobile personal computer (UMPC), a mobile Internet device (MID), an augmented reality (AR)/virtual reality (VR) device, a robot, a wearable device, vehicle-mounted user equipment (VUE), pedestrian user equipment (PUE), a smart home device (a home device with a wireless communication function, such as a refrigerator, a television, a washing machine, or furniture), a game console, a personal computer (PC), a teller machine, or a self-service machine. The wearable device includes a smart watch, a smart band, a smart headset, smart glasses, smart jewelry (a smart bangle, a smart bracelet, a smart ring, a smart necklace, a smart anklet bracelet, a smart anklet chain, or the like), a smart wrist strap, a smart dress, and the like. It should be noted that a specific type of the terminal 11 is not limited in the embodiments of this application. The network side device 12 may include an access network device or a core network device. The access network device may also be referred to as a radio access network device, a radio access network (RAN), a radio access network function, or a radio access network unit. The access network device may include a base station, a wireless local area network (WLAN) access point, a WiFi node, or the like. The base station may be referred to as a NodeB, an evolved NodeB (eNB), an access point, a base transceiver station (BTS), a radio base station, a radio transceiver, a basic service set (BSS), an extended service set (ESS), a home NodeB, a home evolved NodeB, a transmitting receiving point (TRP), or another proper term in the art. The base station is not limited to a specific technical word provided that a same technical effect is achieved. It should be noted that in the embodiments of this application, a base station in an NR system is merely used as an example for description, but does not limit a specific type of the base station.

For better understanding of the technical solutions of this application, related concepts that may possibly be involved in the embodiments of this application are explained and described below.

It can be learned from information theory that accurate channel state information (CSI) is crucial for a channel capacity. In particular, for a multi-antenna system, a transmit end may optimize signal sending based on CSI, so that signal sending matches a channel status to a larger degree. For example, a channel quality indicator (CQI) may be used to select a proper modulation and coding scheme (MCS) to implement link adaptation, and a precoding matrix indicator (PMI) may be used to implement eigen beamforming to maximize received signal strength or to suppress interference (for example, inter-cell interference or multi-user interference). Therefore, CSI acquisition has always been a research hotspot since a multi-antenna technology (multi-input multi-output, MIMO) was proposed.

Generally, a network side device (for example, a base station) sends a CSI reference signal (channel state information reference signal, CSI-RS) on some time-frequency resources of a slot. The terminal performs channel estimation based on the CSI-RS, calculates channel information on the slot, and feeds back a PMI to the base station by using a codebook. The base station combines codebook information fed back by the terminal to form channel information. Before next CSI reporting, the base station performs data precoding and multi-user scheduling by using the channel information.

To further reduce CSI feedback overheads, the terminal may change “reporting a PMI on each sub-band” into a “reporting a PMI based on a delay”. Because channels in a delay domain are more centralized, PMIs of all sub-bands may be approximately represented by using PMIs of fewer delays, that is, information of the delay domain is compressed before being reported.

Similarly, to reduce overheads, the base station may precode the CSI-RS in advance, and send an encoded CSI-RS to the terminal. What is observed by the terminal is a channel corresponding to the encoded CSI-RS. The terminal only needs to select several ports of relatively high strength from ports indicated by a network side, and report coefficients corresponding to these ports.

Further, to better compress channel information, a neural network or a machine learning method may be used. Specifically, the terminal compresses and encodes the channel information by using an AI network model, and the base station decodes compressed content by using an AI network model, to restore the channel information. In this case, the AI network model used by the base station for decoding and the AI network model used by the terminal for encoding need to be jointly trained to achieve a proper degree of matching. The network side performs joint training by using a joint neural network model formed by the AI network model used by the terminal for encoding and the AI network model used by the base station for decoding. After training, the base station sends the AI network model used for encoding to the terminal.

The terminal estimates a CSI-RS, calculates channel information, obtains an encoding result from the calculated channel information or original estimated channel information by using the AI network model, and sends the encoding result to the base station. The base station receives the encoding result, inputs the encoding result into the AI network model for decoding, and restores the channel information.

For a high-rank channel, energy of the channel itself is not concentrated. The channel may be divided into several independent channels through precoding, and the channels do not interfere with each other. This is quite suitable for performing parallel data transmission and improving a throughput. In this case, the terminal needs to feed back channel information or PMI information of a plurality of layers. Generally, the terminal performs singular value decomposition (SVD) on a channel matrix to obtain first several columns of a V-matrix as PMI information to be reported. In descending order of eigenvalues (or referred to as singular values), columns with larger eigenvalues are selected, where eigenvalues of layer1, layer2, . . . decrease in sequence, which indicates that proportions of channel information to an entire channel also decrease in sequence.

The channel feature information transmission method provided in the embodiments of this application is described in detail below with reference to the accompanying drawings by using some embodiments and application scenarios thereof.

Referring to FIG. 2, FIG. 2 is a flowchart of a channel feature information transmission method according to an embodiment of this application. The method is applied to a terminal. As shown in FIG. 2, the method includes the following steps:

Step 201: A terminal inputs channel information of each layer into a corresponding first AI network model for processing, and obtains channel feature information output by the first AI network model, where one layer corresponds to one first AI network model.

Optionally, the terminal may detect a CSI reference signal (CSI-RS) or a tracking reference signal (TRS) at a location specified by a network side device, and perform channel estimation to obtain original channel information, that is, one channel matrix for each sub-band. The terminal performs SVD decomposition on the original channel information, and obtains a precoding matrix on each sub-band. The precoding matrix includes N layers. The terminal inputs a precoding matrix (that is, channel information) of each layer into the first AI network model. Precoding matrices of one layer on each sub-band are input into the first AI network model together, or the precoding matrix is input into the first AI network model after being preprocessed. Further, the terminal further processes the input channel information (such as a channel matrix of each sub-band, or a precoding matrix of each sub-band) by using the first AI network model, for example, encodes the channel information to obtain channel feature information output by the first AI network model. In some embodiments, the channel feature information may also be referred to as bit information, a bit sequence, or the like.

It should be noted that channel information encoding mentioned in this embodiment of this application is different from channel encoding.

Optionally, the channel information that is input into the first AI network model mentioned in this embodiment of this application is precoding information, such as a precoding matrix, PMI information, or a processed precoding matrix.

Step 202: The terminal reports the channel feature information corresponding to each layer to a network side device.

It may be understood that after obtaining the channel feature information output by the first AI network model corresponding to each layer, the terminal reports the channel feature information corresponding to each layer to the network side device. Optionally, the terminal may report the channel feature information corresponding to each layer separately or jointly.

In this embodiment of this application, the terminal may input the channel information corresponding to each layer into the corresponding first AI network model for processing, and report the channel feature information output by the first AI network model of each layer to the network side device. In this application, each layer on a terminal side corresponds to one first AI network model, and therefore, channel information of each layer is processed by using a corresponding first AI network model regardless of a quantity of layers on the terminal side. In this way, there is no need to train different AI network models for different quantities of layers, transmission overheads between the network side device and the terminal for an AI network model can be reduced, power consumption of the terminal and the network side device can be reduced, and in addition, reporting flexibility can be increased.

Optionally, all the layers correspond to a same first AI network model. In other words, the terminal may need only one first AI network model regardless of a quantity of layers that the terminal has. Channel information of each layer is input into a same first AI network model to obtain channel feature information of a corresponding layer. The terminal directly reports the channel feature information of each layer.

For example, a rank of the terminal side is 2, output first channel feature information is obtained from channel information of layer1 by using a first AI network model 1, and output second channel feature information is obtained from channel information of layer2 by using the first AI network model 1. The terminal reports the first channel feature information and the second channel feature information to the network side device.

In this way, the network side device needs to train only one first AI network model and transfer the first AI network model to the terminal regardless of a quantity of layers that the terminal has. This effectively reduces transmission overheads between the network side device and the terminal for an AI network model, and can also reduce power consumption of the terminal.

Optionally, first AI network models corresponding to all layers are different, and lengths of channel feature information output by the first AI network models gradually decrease in a sequence of the layers. In this case, each layer on the terminal side corresponds to one first AI network model, and therefore, the network side device separately trains the first AI network model of each layer, and sends the trained first AI network model to the terminal. The terminal processes channel information of different layers by using first AI network models that are respectively corresponding to the layers. Lengths of channel feature information output by the first AI network models may gradually decrease in the sequence of the layers. For example, a length of channel feature information output by the first AI network model corresponding to layer1 is 200 bits, a length of channel feature information output by the first AI network model corresponding to layer2 is 180 bits, a length of channel feature information output by a first AI network model corresponding to layer3 is 160 bits, . . . . In this way, a length of channel feature information output by the first AI network model corresponding to each layer is limited, to reduce transmission overheads of the terminal.

Optionally, before the terminal inputs the channel information of each layer into the corresponding first AI network model for processing, the method may further include:
determining, by the terminal based on a rank of a channel, a quantity of layers corresponding to the channel information; and
obtaining, by the terminal, a proportion of a target parameter of a first target layer to a sum of target parameters of second target layers, and determining, based on a proportion range in which the proportion is located, a first AI network model corresponding to the first target layer, where the first target layer is any layer in layers corresponding to the channel information, and the second target layers are all layers corresponding to the terminal or all layers reported by the terminal; where
different proportion ranges correspond to different first AI network models, and the target parameter includes any one of the following: an eigenvalue, a channel quality indicator (CQI), and a channel capacity.

Optionally, the terminal may determine a rank of a terminal channel based on a CSI reference signal (CSI-RS) channel estimation result. Based on the rank, a quantity of layers corresponding to channel information of the terminal can be determined. For example, if rank=2, a quantity of layers corresponding to the channel information of the terminal is 2; and if rank=3, the quantity of layers corresponding to the channel information of the terminal is 3.

In this embodiment of this application, a first AI network model of a specific layer of the terminal may be determined based on a proportion of a target parameter of the layer to a sum of target parameters of all layers, or based on a proportion of a target parameter of the layer to a sum of target parameters of all reported layers.

Optionally, the terminal classifies first AI network models corresponding to different proportion ranges in advance. For example, a proportion range 70%-100% corresponds to a first AI network model 001, a proportion range 40%-70% corresponds to a first AI network model 002, and a proportion range less than 40% corresponds to a first AI network model 003. If the terminal selects rank1, and in the example of an eigenvalue, an eigenvalue proportion of layer1 is calculated as 80%, it is determined that layer1 corresponds to the first AI network model 001. If the terminal selects rank2, a proportion of an eigenvalue of layer1 to a sum of eigenvalues of all layers is calculated as 75%, and a proportion of an eigenvalue of layer2 to the sum of the eigenvalues of all the layers is calculated as 20%, it is determined that layer1 corresponds to the first AI network model 001, and layer2 corresponds to the first AI network model 003. Further, the terminal processes the input channel information based on the first AI network model determined for each layer.

In this way, the terminal determines, based on an eigenvalue, a CQI, or a channel capacity of a layer, a first AI network model corresponding to the layer, thereby improving flexibility in determining the channel information by the terminal.

Optionally, layers of the terminal correspond to different first AI network models, and an input of a target first AI network model includes channel information of a third target layer. The layers corresponding to the terminal are sorted based on target parameters, and the third target layer is any one of the sorted layers corresponding to the terminal. The target first AI network model is a first AI network model corresponding to the third target layer, and the target parameter includes any one of the following: an eigenvalue, a CQI, and a channel capacity.

For example, if the third target layer is layer2, an input of a first AI network model corresponding to layer2 includes channel information of layer2; and if the third target layer is layer3, an input of a first AI network model corresponding to layer3 includes channel information of layer3.

Optionally, the third target layer is any one of the sorted layers corresponding to the terminal except the first layer, and the input of the target first AI network model further includes any one of the following:
an output of a first AI network model corresponding to a previous layer of the third target layer;
an output of a first AI network model corresponding to the first layer;
outputs of first AI network models respectively corresponding to all layers before the third target layer;
channel information corresponding to the previous layer of the third target layer; and
channel information respectively corresponding to all layers before the third target layer.

For example, the third target layer is layer3, and an input of the first AI network model corresponding to layer3 may include the following several manners:

Manner 1: Channel information of layer3 and channel feature information that is output by the first AI network model corresponding to layer2.

Manner 2: Channel information of layer3 and channel feature information that is output by the first AI network model corresponding to layer1.

Manner 3: Channel information of layer3, channel feature information that is output by the first AI network model corresponding to layer1, and channel feature information that is output by the first AI network model corresponding to layer2.

Manner 4: Channel information of layer3 and channel information of layer2.

Manner 5: Channel information of layer3, channel information of layer1, and channel information of layer2.

In this embodiment of this application, the terminal may determine, in the foregoing different manners, an input of a first AI network model corresponding to a specific layer of the terminal, so that inputs of first AI network models of all the layers of the terminal may be different, thereby improving flexibility in processing channel information by the terminal.

Optionally, that the terminal inputs the channel information of each layer into the corresponding first AI network model for processing includes:
inputting, by the terminal, the channel information of each layer into the corresponding first AI network model for processing after preprocessing the channel information of each layer.

In other words, before inputting the channel information of each layer into the corresponding first AI network model, the terminal may first preprocess the channel information. For example, the preprocessing may be orthogonal base projection, over-sampling, or the like. It should be noted that the preprocessing is an advance of the orthogonal base projection. In the example of a precoding matrix, if a quantity of CSI-RS ports is 32, a precoding matrix of one layer may be one 32*1 matrix, projection is performed to generate 32 orthogonal DFT vectors, and a length of each DFT vector is 32. The precoding matrix is projected into the 32 orthogonal DFT vectors, and several orthogonal DFT vector with relatively large coefficient amplitudes are selected, and then a coefficient and/or a corresponding DFT vector are/is used as a preprocessing result. Over-sampling is performed during projection. Using 4× over-sampling as an example, four groups of 32 orthogonal DFT vectors are generated, where 32 orthogonal DFT vectors in each group are orthogonal, and groups are not orthogonal. Then, a group that is the closest to the precoding matrix is selected from the four groups, and then, projection is performed in the foregoing manner.

Optionally, that the terminal inputs the channel information of each layer into the corresponding first AI network model for processing after preprocessing the channel information of each layer includes any one of the following:
inputting, by the terminal, the channel information of each layer into the corresponding first AI network model after preprocessing the channel information of each layer by using a second AI network model; and
after preprocessing channel information of a target layer by using a target second AI network model, inputting, by the terminal, an output of the target second AI network model into a first AI network model corresponding to the target layer, where the target layer is any layer corresponding to the terminal, and each layer corresponds to one target second AI network model.

In this embodiment of this application, the terminal may alternatively preprocess the channel information by using the second AI network model.

For example, the terminal preprocesses the channel information of each layer by using a same second AI network model, and then inputs an input of the second AI network model corresponding to each layer into the first AI network model corresponding to each layer. In this way, the network side device may train only one second AI network model, thereby reducing power consumption of the network side device and the terminal.

Alternatively, the network side device may train one second AI network model for each layer, and then preprocess channel information of each layer by using a corresponding second AI network model, and then use an output of the second AI network model as an input of a first AI network model of the corresponding layer. In this way, channel information can be preprocessed by using different second AI network models, thereby improving flexibility in preprocessing channel information of each layer by the terminal.

In this embodiment of this application, that the terminal reports the channel feature information corresponding to each layer to the network side device includes:
post-processing, by the terminal, channel feature information corresponding to a target layer, and reporting the post-processed channel feature information to the network side device, where the target layer is any layer corresponding to the terminal.

It should be noted that the terminal may post-process the channel feature information corresponding to each layer before reporting the channel feature information to the network side device, or may post-process channel feature information corresponding to only one or more specified layers before reporting the post-processed channel feature information to the network side device.

Optionally, the post-processing manner may be entropy coding, interception of a target length performed on channel feature information output by the first AI network model, or the like.

Optionally, that the terminal performs post-processing on the channel feature information corresponding to the target layer, and reporting the post-processed channel feature information to the network side device includes:
post-processing, by the terminal, the channel feature information corresponding to the target layer to obtain channel feature information of a target length, where the target length is less than a length of the channel feature information that is not post-processed; and
reporting, by the terminal, the target length and the channel feature information of the target length to the network side device.

For example, when rank=2, after channel information of layer1 is processed by using a corresponding first AI network model, channel feature information 1 whose length is 100 bits that is output by the first AI network model is obtained, and after channel information of layer2 is processed by using a corresponding first AI network model, channel feature information 2 whose length is 80 bits that is output by the first AI network model is obtained. The terminal may post-process the channel feature information 2 of layer2 without performing post-processing on the channel feature information 1 of layer1, to obtain channel feature information of 80 bits. In this case, the terminal may report the following information to the network side device: the channel feature information 1 of 100 bits, the channel feature information 2 of 80 bits, and a length (that is, 80 bits) of the channel feature information 2. In this way, the network side device can decode the channel feature information based on the reported information by using a third AI network model that matches the first AI network model, to obtain restored channel information.

Optionally, the post-processing manner may be indicated by the network side device, or may be independently selected by the terminal.

In this embodiment of this application, in a case that the channel feature information is reported by using CSI, the target length is included in a first part of the CSI.

For example, the terminal may report the channel feature information by using one piece of CSI. The CSI includes a first part (CSI Part1) and a second part (CSI Part2), where the first part is a part of a fixed length in the CSI, and the second part is a part of a variable length in the CSI. The terminal may add the channel feature information into CSI Part1, and also add the target length of the channel feature information of the target layer to CSI Part1. Further, the network side device can directly obtain the channel feature information of the target layer and the length of the channel feature information from CSI Part1, to decode the channel feature information.

Optionally, in a case that the channel feature information is reported by using the CSI, that the terminal reports the channel feature information corresponding to each layer to the network side device includes any one of the following:
in a case that the layers corresponding to the terminal are sorted based on the target parameter, reporting, by the terminal, the channel feature information corresponding to the first layer to the network side device by using the first part of the CSI, and reporting channel feature information corresponding to other layers except the first layer by using a second part of the CSI, where the target parameter includes any one of the following: an eigenvalue, a CQI, and a channel capacity;
reporting, by the terminal, the channel feature information corresponding to each layer to the network side device by using the second part of the CSI; and
reporting, by the terminal, the channel feature information corresponding to each layer to the network side device by using a corresponding block in the second part of the CSI, where one layer corresponds to one block.

For example, the terminal reports channel feature information corresponding to the first layer by using CSI Part1, and reports channel feature information corresponding to another layer than the first layer by using CSI Part2; or the terminal reports channel feature information of all the layers by using CSI Part2; or CSI Part2 may be divided into blocks, and the terminal reports the channel feature information of each layer by using one corresponding block in CSI Part2. In this way, a manner in which the terminal reports the channel feature information is more flexible.

Optionally, that the terminal reports the channel feature information corresponding to each layer to the network side device includes:
reporting, by the terminal, the channel feature information corresponding to each layer to the network side device, and discarding the channel feature information in a reverse order of an order of the layers.

In this embodiment of this application, in a process in which the terminal reports the channel feature information corresponding to each layer to the network side device, the terminal may further discard the channel feature information. For example, if resources are insufficient, the terminal may discard the channel feature information in a reverse sequence of the layers, to ensure that channel feature information of a previous layer can be transmitted to the network side device.

Optionally, the method further includes:
determining, by the terminal, the rank of the channel based on a CSI reference signal channel estimation result; and
that the terminal reports the channel feature information corresponding to each layer to the network side device includes:
reporting, by the terminal, a rank indicator (RI) and the channel feature information corresponding to each layer to the network side device.

In this embodiment of this application, the terminal determines the rank of the channel based on a CSI-RS channel estimation result, so that a quantity of layers corresponding to the terminal can be determined. After the terminal separately inputs the channel information of each layer into the corresponding first AI network model to obtain the channel feature information output by the first AI network model, the terminal reports the RI and the channel feature information corresponding to each layer to the network side device, so that the network side device can restore the channel information based on the RI and the channel feature information.

Referring to FIG. 3, FIG. 3 is a flowchart of another channel feature information transmission method according to an embodiment of this application. The method is applied to a network side device. As shown in FIG. 3, the method includes the following steps:

Step 301: A network side device receives channel feature information corresponding to each layer that is reported by a terminal.

One layer of the terminal corresponds to one first AI network model, and the first AI network model is used to process channel information of a layer that is input by the terminal and output the channel feature information.

It should be noted that the network side device includes a third AI network model that matches the first AI network model, the first AI network model and the third AI network model are jointly trained by the network side device, and the network side device sends the trained first AI network model to the terminal. The terminal performs encodes an input coefficient by using the first AI network model, and outputs the channel feature information. The terminal reports the channel feature information to the network side device. The network side device inputs the channel feature information into a matched third AI network model. The third AI network model decodes the channel feature information to obtain channel information to be output by the third AI network model. Therefore, the network side device restores the channel information by using the third AI network model. In this way, the terminal and the network side device can encode and decode the channel information by using the matched AI network model.

In this embodiment of this application, the terminal inputs the channel information corresponding to each layer into the corresponding first AI network model for processing, and report the channel feature information output by the first AI network model of each layer to the network side device. Compared with a related technology in which a network side device needs to train different AI network models for different quantities of layers of a terminal, in this application, the network side device may correspondingly train one first AI network model for each layer on a terminal side, and therefore, channel information of each layer is processed by using a corresponding first AI network model regardless of a quantity of layers on the terminal side. In this way, there is no need to train different AI network models for different quantities of layers, thereby effectively reducing power consumption of the network side device, and reducing transmission overheads between the network side device and the terminal for an AI network model.

Optionally, all the layers correspond to a same first AI network model. In other words, the terminal may need only one first AI network model regardless of a quantity of layers that the terminal has. Channel information of each layer is input into a same first AI network model, so that the network side device may need to train only one first AI network model and transmit the first AI network model to the terminal, thereby effectively reducing power consumption and transmission overheads of the network side device.

Optionally, first AI network models corresponding to all layers are different, and lengths of channel feature information output by the first AI network models gradually decrease in a sequence of the layers. In this case, each layer on the terminal side corresponds to one first AI network model, and therefore, the network side device separately trains the first AI network model of each layer, sends the trained first AI network model to the terminal, and defines an input length of the first AI network model corresponding to each layer. In this way, transmission overheads of the terminal can be reduced.

Optionally, in a case that the channel feature information is reported by using CSI, that the network side device receives the channel feature information corresponding to each layer that is reported by the terminal includes any one of the following:
in a case that the layers corresponding to the terminal are sorted based on a target parameter, receiving, by the network side device, channel feature information corresponding to the first layer that is reported by the terminal by using a first part of the CSI, and channel feature information corresponding to other layers except the first layer that is reported by using a second part of the CSI, where the target parameter includes any one of the following: an eigenvalue, a CQI, and a channel capacity;
receiving, by the network side device, channel feature information corresponding to each layer that is reported by the terminal by using the second part of the CSI; and
receiving, by the network side device, channel feature information corresponding to each layer that is reported by the terminal by using a corresponding block in the second part of the CSI, where one layer corresponds to one block.

In this way, a manner in which the terminal reports the channel feature information is more flexible.

Optionally, that the network side device receives the channel feature information corresponding to each layer that is reported by the terminal includes:
receiving, by the network side device, an RI and the channel feature information corresponding to each layer that are reported by the terminal.

In this embodiment of this application, the terminal reports the RI and the channel feature information corresponding to each layer to the network side device, so that the network side device can restore the channel information based on the RI and the channel feature information.

It should be noted that, the channel feature information transmission method applied to the network side device provided in this embodiment of this application is corresponding to the foregoing method applied to the terminal side. A related concept and a specific implementation procedure in this embodiment of this application may be described with reference to the foregoing embodiment in FIG. 2. To avoid repetition, details are not described in this embodiment.

The channel feature information transmission method provided in this embodiment of this application may be performed by a channel feature information transmission apparatus. In this embodiment of this application, that the channel feature information transmission apparatus performs the channel feature information transmission method is used as an example to describe the channel feature information transmission apparatus provided in this embodiment of this application.

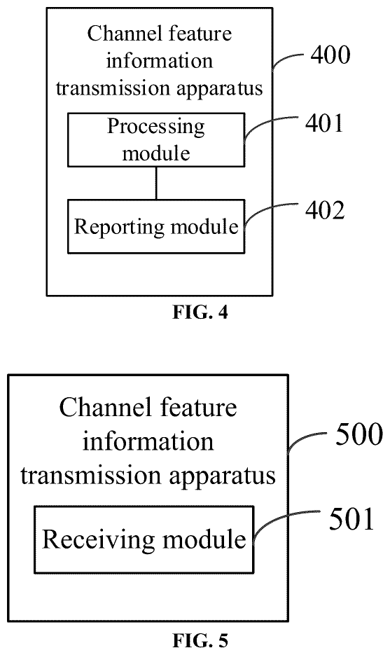

Referring to FIG. 4, FIG. 4 is a structural diagram of a channel feature information transmission apparatus according to an embodiment of this application. As shown in FIG. 4, the channel feature information transmission apparatus 400 includes:
a processing module 401, configured to: input channel information of each layer into a corresponding first artificial intelligence AI network model for processing, and obtain channel feature information output by the first AI network model, where one layer corresponds to one first AI network model; and
a reporting module 402, configured to report the channel feature information corresponding to each layer to a network side device.

Optionally, all the layers correspond to a same first AI network model.

Optionally, first AI network models corresponding to all layers are different, and lengths of channel feature information output by the first AI network models gradually decrease in a sequence of the layers.

Optionally, the apparatus further includes a determining module, configured to:
determine, based on a rank of a channel, a quantity of layers corresponding to the channel information; and
obtain a proportion of a target parameter of a first target layer to a sum of target parameters of second target layers, and determine, based on a proportion range in which the proportion is located, a first AI network model corresponding to the first target layer, where the first target layer is any layer in layers corresponding to the channel information, and the second target layers are all layers corresponding to the apparatus or all layers reported by the apparatus; where
different proportion ranges correspond to different first AI network models, and the target parameter includes any one of the following: an eigenvalue, a CQI, and a channel capacity.

Optionally, first AI network models corresponding to all layers are different, and an input of a target first AI network model includes channel information of a third target layer; where
layers corresponding to the apparatus are sorted based on a target parameter, the third target layer is any one of the sorted layers corresponding to the apparatus, the target first AI network model is a first AI network model corresponding to the third target layer, and the target parameter includes any one of the following: an eigenvalue, a CQI, and a channel capacity.

Optionally, the third target layer is any one of the sorted layers corresponding to the apparatus except the first layer, and the input of the target first AI network model further includes any one of the following:
an output of a first AI network model corresponding to a previous layer of the third target layer;
an output of a first AI network model corresponding to the first layer;
outputs of first AI network models respectively corresponding to all layers before the third target layer;
channel information corresponding to the previous layer of the third target layer; and
channel information respectively corresponding to all layers before the third target layer.

Optionally, the processing module 401 is further configured to:
input the channel information of each layer into the corresponding first AI network model for processing after preprocessing the channel information of each layer.

Optionally, the processing module 401 is further configured to perform any one of the following:
inputting the channel information of each layer into the corresponding first AI network model after preprocessing the channel information of each layer by using a second AI network model; and
after preprocessing channel information of a target layer by using a target second AI network model, inputting an output of the target second AI network model into a first AI network model corresponding to the target layer, where the target layer is any layer corresponding to the apparatus, and each layer corresponds to one target second AI network model.

Optionally, the reporting module 402 is further configured to:
post-process channel feature information corresponding to a target layer, and report the post-processed channel feature information to the network side device; where
the target layer is at least one layer corresponding to the apparatus.

Optionally, the reporting module 402 is further configured to:
post-process the channel feature information corresponding to the target layer to obtain channel feature information of a target length, where the target length is less than a length of the channel feature information that is not post-processed; and
report the target length and the channel feature information of the target length to the network side device.

Optionally, in a case that the channel feature information is reported by using channel state information CSI, the target length is included in a first part of the CSI.

Optionally, in a case that the channel feature information is reported by using the CSI, the reporting module 402 is further configured to perform any one of the following:
in a case that the layers corresponding to the apparatus are sorted based on the target parameter, reporting the channel feature information corresponding to the first layer to the network side device by using a first part of the CSI, and reporting channel feature information corresponding to other layers except the first layer by using a second part of the CSI, where the target parameter includes any one of the following: an eigenvalue, a CQI, and a channel capacity;
reporting the channel feature information corresponding to each layer to the network side device by using the second part of the CSI; and
reporting the channel feature information corresponding to each layer to the network side device by using a corresponding block in the second part of the CSI, where one layer corresponds to one block.

Optionally, the reporting module 402 is further configured to:
report the channel feature information corresponding to each layer to the network side device, and discard the channel feature information in a reverse order of an order of the layers.

Optionally, the apparatus further includes:
a determining module, configured to determine the rank of the channel based on a CSI reference signal channel estimation result.

The reporting module 402 is further configured to:
report a rank indicator RI and the channel feature information corresponding to each layer to the network side device.

Optionally, the channel information is precoding information.

In this embodiment of this application, the apparatus may input the channel information corresponding to each layer into the corresponding first AI network model for processing, and report the channel feature information output by the first AI network model of each layer to the network side device. Compared with a related technology in which a network side device needs to train different AI network models for different quantities of layers, in this application, each layer of the apparatus corresponds to one first AI network model. In this way, there is no need to train different AI network models for different quantities of layers, transmission overheads between the network side device and the apparatus can be reduced, and power consumption of the apparatus can be reduced.

The channel feature information transmission apparatus 400 in this embodiment of this application may be an electronic device, for example, an electronic device with an operating system, or may be a component in the electronic device, for example, an integrated circuit or a chip. The electronic device may be a terminal, or another device other than the terminal. For example, the terminal may include but is not limited to the foregoing listed types of the terminal 11, and the another device may be a server, a network attached storage (NAS), or the like. This is not specifically limited in this embodiment of this application.

The channel feature information transmission apparatus 400 provided in this embodiment of this application can implement the processes implemented by the terminal in the method embodiment of FIG. 2, and a same technical effect is achieved. To avoid repetition, details are not described herein again.

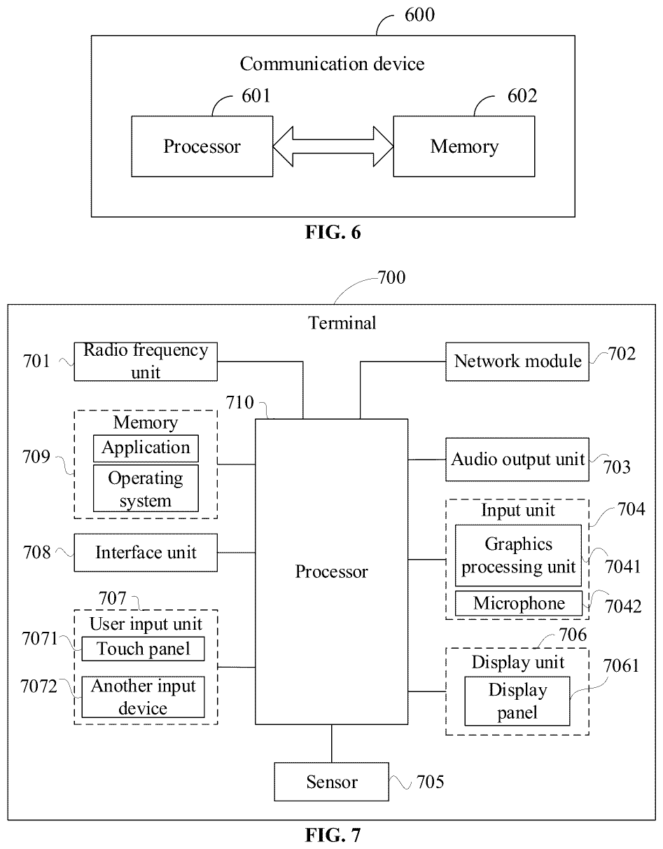

Referring to FIG. 5, FIG. 5 is a structural diagram of another channel feature information transmission apparatus according to an embodiment of this application. As shown in FIG. 5, the channel feature information transmission apparatus 500 includes:
a receiving module 501, configured to receive channel feature information corresponding to each layer that is reported by a terminal; where

One layer of the terminal corresponds to one first AI network model, and the first AI network model is used to process channel information of a layer that is input by the terminal and output the channel feature information.

Optionally, all the layers correspond to a same first AI network model.

Optionally, first AI network models corresponding to all layers are different, and lengths of channel feature information output by the first AI network models gradually decrease in a sequence of the layers.

Optionally, in a case that the channel feature information is reported by using the CSI, the receiving module 501 is further configured to perform any one of the following:
in a case that the layers corresponding to the terminal are sorted based on a target parameter, receiving channel feature information corresponding to the first layer that is reported by the terminal by using a first part of the CSI, and channel feature information corresponding to other layers except the first layer that is reported by using a second part of the CSI, where the target parameter includes any one of the following: an eigenvalue, a CQI, and a channel capacity;
receiving channel feature information corresponding to each layer that is reported by the terminal by using the second part of the CSI; and
receiving channel feature information corresponding to each layer that is reported by the terminal by using a corresponding block in the second part of the CSI, where one layer corresponds to one block.

Optionally, the receiving module 501 is further configured to:
receive a rank indicator RI and the channel feature information corresponding to each layer that are reported by the terminal.

In this embodiment of this application, the apparatus may correspondingly train one first AI network model for each layer on a terminal side, and therefore, channel information of each layer is processed by using a corresponding first AI network model regardless of a quantity of layers on the terminal side. In this way, there is no need to train different AI network models for different quantities of layers, thereby effectively reducing power consumption of the apparatus, and reducing transmission overheads between the apparatus and the terminal for an AI network model.

The channel feature information transmission apparatus 500 provided in this embodiment of this application can implement the processes implemented by the network side device in the method embodiment of FIG. 3, and a same technical effect is achieved. To avoid repetition, details are not described herein again.

Optionally, as shown in FIG. 6, an embodiment of this application further provides a communication device 600, including a processor 601 and a memory 602, and the memory 602 stores a program or an instruction that can be run on the processor 601. For example, in a case that the communication device 600 is a terminal, when the program or the instruction is executed by the processor 601, the steps of the foregoing method embodiment in FIG. 2 are implemented, and a same technical effect can be achieved. In a case that the communication device 600 is a network side device, when the program or the instruction is executed by the processor 601, the steps of the method embodiment in FIG. 3 are implemented, and a same technical effect can be achieved. To avoid repetition, details are not described herein again.

An embodiment of this application further provides a terminal, including a processor and a communication interface. The processor is configured to: input channel information of each layer into a corresponding first artificial intelligence AI network model for processing, and obtain channel feature information output by the first AI network model, where one layer corresponds to one first AI network model. The communication interface is configured to report the channel feature information corresponding to each layer to a network side device. The terminal embodiment is corresponding to the method embodiment on the terminal side, each implementation process and implementation of the method embodiment can be applied to the terminal embodiment, and a same technical effect can be achieved. Specifically, FIG. 7 is a schematic diagram of a hardware structure of a terminal according to an embodiment of this application.

A terminal 700 includes but is not limited to at least a part of components such as a radio frequency unit 701, a network module 702, an audio output unit 703, an input unit 704, a sensor 705, a display unit 706, a user input unit 707, an interface unit 708, a memory 709, and a processor 710.

A person skilled in the art can understand that the terminal 700 may further include a power supply (such as a battery) that supplies power to each component. The power supply may be logically connected to the processor 710 by using a power supply management system, to implement functions such as charging and discharging management, and power consumption management by using the power supply management system. The terminal structure shown in FIG. 7 constitutes no limitation on the terminal, and the terminal may include more or fewer components than those shown in the figure, or combine some components, or have different component arrangements. Details are not described herein.

It should be understood that in this embodiment of this application, the input unit 704 may include a graphics processing unit (GPU) 7041 and a microphone 7042. The graphics processing unit 7041 processes image data of a static picture or a video obtained by an image capture apparatus (for example, a camera) in a video capture mode or an image capture mode. The display unit 706 may include a display panel 7061, and the display panel 7061 may be configured in a form of a liquid crystal display, an organic light-emitting diode, or the like. The user input unit 707 includes at least one of a touch panel 7071 and another input device 7072. The touch panel 7071 is also referred to as a touchscreen. The touch panel 7071 may include two parts: a touch detection apparatus and a touch controller. The another input device 7072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 701 may transmit the downlink data to the processor 710 for processing. In addition, the radio frequency unit 701 may send uplink data to the network side device. Generally, the radio frequency unit 701 includes but is not limited to an antenna, an amplifier, a transceiver, a coupler, a low noise amplifier, a duplexer, and the like.

The memory 709 may be configured to store a software program or an instruction and various data. The memory 709 may mainly include a first storage area for storing a program or an instruction and a second storage area for storing data. The first storage area may store an operating system, and an application or an instruction required by at least one function (for example, a sound playing function or an image playing function). In addition, the memory 709 may be a volatile memory or a non-volatile memory, or the memory 709 may include a volatile memory and a non-volatile memory. The non-volatile memory may be a read-only memory (ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synchlink dynamic random access memory (Synch link DRAM, SLDRAM), and a direct rambus random access memory (Direct Rambus RAM, DRRAM). The memory 709 in this embodiment of this application includes but is not limited to these memories and any memory of another proper type.

The processor 710 may include one or more processing units. Optionally, an application processor and a modem processor are integrated into the processor 710. The application processor mainly processes an operating system, a user interface, an application, or the like. The modem processor mainly processes a wireless communication signal, for example, a baseband processor. It may be understood that, alternatively, the modem processor may not be integrated into the processor 710.

The processor 710 is configured to: input channel information of each layer into a corresponding first artificial intelligence AI network model for processing, and obtain channel feature information output by the first AI network model, where one layer corresponds to one first AI network model.

The radio frequency unit 701 is configured to report the channel feature information corresponding to each layer to a network side device.

Optionally, all the layers correspond to a same first AI network model.

Optionally, first AI network models corresponding to all layers are different, and lengths of channel feature information output by the first AI network models gradually decrease in a sequence of the layers.

Optionally, the processor 710 is further configured to:
determine, based on a rank of a channel, a quantity of layers corresponding to the channel information; and
obtain a proportion of a target parameter of a first target layer to a sum of target parameters of second target layers, and determine, based on a proportion range in which the proportion is located, a first AI network model corresponding to the first target layer, where the first target layer is any layer in layers corresponding to the channel information, and the second target layers are all layers corresponding to the terminal or all layers reported by the terminal; where
different proportion ranges correspond to different first AI network models, and the target parameter includes any one of the following: an eigenvalue, a CQI, and a channel capacity.

Optionally, first AI network models corresponding to all layers are different, and an input of a target first AI network model includes channel information of a third target layer; where
layers corresponding to the terminal are sorted based on a target parameter, the third target layer is any one of the sorted layers corresponding to the terminal, the target first AI network model is a first AI network model corresponding to the third target layer, and the target parameter includes any one of the following: an eigenvalue, a CQI, and a channel capacity.

Optionally, the third target layer is any one of the sorted layers corresponding to the terminal except the first layer, and the input of the target first AI network model further includes any one of the following:
an output of a first AI network model corresponding to a previous layer of the third target layer;
an output of a first AI network model corresponding to the first layer;
outputs of first AI network models respectively corresponding to all layers before the third target layer;
channel information corresponding to the previous layer of the third target layer; and
channel information respectively corresponding to all layers before the third target layer.

Optionally, the processor 710 is further configured to:
input the channel information of each layer into the corresponding first AI network model for processing after preprocessing the channel information of each layer.

Optionally, the processor 710 is further configured to any one of the following:
inputting the channel information of each layer into the corresponding first AI network model after preprocessing the channel information of each layer by using a second AI network model; and
after preprocessing channel information of a target layer by using a target second AI network model, inputting an output of the target second AI network model into a first AI network model corresponding to the target layer, where the target layer is any layer corresponding to the terminal, and each layer corresponds to one target second AI network model.

Optionally, the radio frequency unit 701 is further configured to:
post-process channel feature information corresponding to a target layer, and report the post-processed channel feature information to the network side device; where
the target layer is at least one layer corresponding to the terminal.

Optionally, the radio frequency unit 701 is further configured to:
post-process the channel feature information corresponding to the target layer to obtain channel feature information of a target length, where the target length is less than a length of the channel feature information that is not post-processed; and
report the target length and the channel feature information of the target length to the network side device.

Optionally, in a case that the channel feature information is reported by using channel state information CSI, the target length is included in a first part of the CSI.

Optionally, in a case that the channel feature information is reported by using the CSI, the radio frequency unit 701 is further configured to perform any one of the following:
in a case that the layers corresponding to the terminal are sorted based on the target parameter, reporting the channel feature information corresponding to the first layer to the network side device by using a first part of the CSI, and reporting channel feature information corresponding to other layers except the first layer by using a second part of the CSI, where the target parameter includes any one of the following: an eigenvalue, a CQI, and a channel capacity;
reporting the channel feature information corresponding to each layer to the network side device by using the second part of the CSI; and
reporting the channel feature information corresponding to each layer to the network side device by using a corresponding block in the second part of the CSI, where one layer corresponds to one block.

Optionally, the radio frequency unit 701 is further configured to:
report the channel feature information corresponding to each layer to the network side device, and discard the channel feature information in a reverse order of an order of the layers.

Optionally, the processor 710 is further configured to determine the rank of the channel based on a CSI reference signal channel estimation result.

The radio frequency unit 701 is further configured to report an RI and the channel feature information corresponding to each layer to the network side device.

Optionally, the channel information is precoding information.

In this embodiment of this application, each layer of the terminal corresponds to one first AI network model, and therefore, channel information of each layer is processed by using a corresponding first AI network model regardless of a quantity of layers on a terminal side. In this way, there is no need to train different AI network models for different quantities of layers, transmission overheads between the network side device and the terminal for an AI network model can be reduced, and power consumption of the terminal and the network side device can be reduced.

An embodiment of this application further provides a network side device, including a processor and a communication interface. The communication interface is configured to receive channel feature information corresponding to each layer that is reported by a terminal, where one layer of the terminal corresponds to one first AI network model, and the first AI network model is used to process channel information of a layer that is input by the terminal and output the channel feature information. This network side device embodiment is corresponding to the foregoing method embodiment of the network side device. Each implementation process and implementation of the foregoing method embodiment may be applicable to this network side device embodiment, and a same technical effect can be achieved.

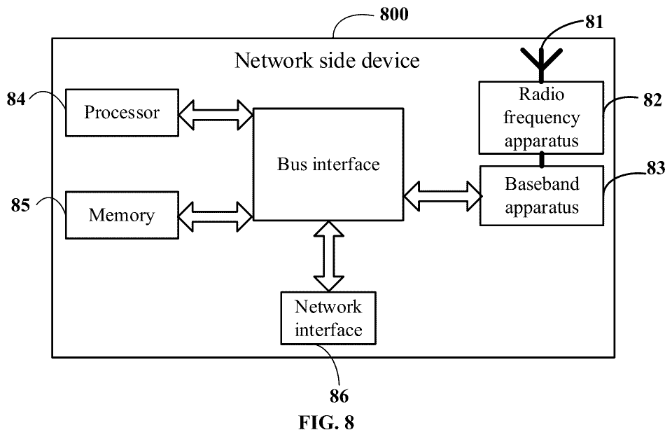

Specifically, an embodiment of this application further provides a network side device. As shown in FIG. 8, the network side device 800 includes an antenna 81, a radio frequency apparatus 82, a baseband apparatus 83, a processor 84, and a memory 85. The antenna 81 is connected to the radio frequency apparatus 82. In an uplink direction, the radio frequency apparatus 82 receives information by using the antenna 81, and sends the received information to the baseband apparatus 83 for processing. In a downlink direction, the baseband apparatus 83 processes information that needs to be sent, and sends processed information to the radio frequency apparatus 82. The radio frequency apparatus 82 processes the received information, and sends processed information by using the antenna 81.

In the foregoing embodiment, the method performed by the network side device may be implemented in a baseband apparatus 83. The baseband apparatus 83 includes a baseband processor.

For example, the baseband apparatus 83 may include at least one baseband board. A plurality of chips are disposed on the baseband board. As shown in FIG. 8, one chip is, for example, a baseband processor, and is connected to the memory 85 by using a bus interface, to invoke a program in the memory 85 to perform the operations of the network device shown in the foregoing method embodiment.

The network side device may further include a network interface 86, and the interface is, for example, a common public radio interface (CPRI).

Specifically, the network side device 800 in this embodiment of the present invention further includes an instruction or a program that is stored in the memory 85 and that can be run on the processor 84. The processor 84 invokes the instruction or the program in the memory 85 to perform the method performed by the modules shown in FIG. 5, and a same technical effect is achieved. To avoid repetition, details are not described herein again.

An embodiment of this application further provides a readable storage medium. The readable storage medium stores a program or an instruction, and when the program or the instruction is executed by a processor, the processes of the method embodiment in FIG. 2 are implemented, or the processes of the method embodiment in FIG. 3 are implemented, and a same technical effect can be achieved. To avoid repetition, details are not described herein again.

The processor is a processor in the terminal in the foregoing embodiments. The readable storage medium includes a computer-readable storage medium, such as a computer read-only memory ROM, a random access memory RAM, a magnetic disk, or an optical disc.

An embodiment of this application further provides a chip. The chip includes a processor and a communication interface, the communication interface is coupled to the processor, and the processor is configured to run a program or an instruction to implement the processes of the method embodiment in FIG. 2 or implement the processes of the method embodiment in FIG. 3, and a same technical effect can be achieved. To avoid repetition, details are not described herein again.

It should be understood that the chip mentioned in this embodiment of this application may also be referred to as a system-level chip, a system chip, a chip system, or a system on chip.

An embodiment of this application further provides a computer program/program product, the computer program/program product is stored in a storage medium, and the computer program/program product is executed by at least one processor to implement the processes of the method embodiment in FIG. 2 or implement the processes of the method embodiment in FIG. 3, and a same technical effect can be achieved. To avoid repetition, details are not described herein again.

An embodiment of this application further provides a communication system, including a terminal and a network side device, where the terminal may be configured to perform the steps of the channel feature information transmission method described in FIG. 2, and the network side device may be configured to perform the steps of the channel feature information transmission method described in FIG. 3.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the methods and apparatuses in the embodiments of this application is not limited to performing functions in the order shown or discussed, but may also include performing the functions in a basically simultaneous manner or in opposite order based on the functions involved. For example, the described methods may be performed in a different order from the described order, and various steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. In most circumstances, the former is a preferred implementation. Based on such an understanding, the technical solutions of this application essentially or the part contributing to the related art may be implemented in a form of a computer software product. The computer software product is stored in a storage medium (for example, a ROM/RAM, a floppy disk, or an optical disc), and includes several instructions for instructing a terminal (which may be a mobile phone, a computer, a server, an air conditioner, a network device, or the like) to perform the methods described in the embodiments of this application.

The embodiments of this application are described above with reference to the accompanying drawings, but this application is not limited to the foregoing specific implementations, and the foregoing specific implementations are only illustrative and not restrictive. Under the enlightenment of this application, a person of ordinary skill in the art can make many forms without departing from the purpose of this application and the protection scope of the claims, all of which fall within the protection of this application.

What is claimed is:

1. A channel feature information transmission method, comprising:
inputting, by a terminal, channel information of each layer into a corresponding first artificial intelligence (AI) network model for processing, and obtaining channel feature information output by the first AI network model, wherein one layer corresponds to one first AI network model; and
reporting, by the terminal, the channel feature information corresponding to each layer to a network side device.

2. The method according to claim 1, wherein first AI network models corresponding to all layers are different, and lengths of channel feature information output by the first AI network models gradually decrease in a sequence of the layers.

3. The method according to claim 1, wherein before the inputting, by a terminal, channel information of each layer into a corresponding first AI network model for processing, the method further comprises:
determining, by the terminal based on a rank of a channel, a quantity of layers corresponding to the channel information; and
obtaining, by the terminal, a proportion of a target parameter of a first target layer to a sum of target parameters of second target layers, and determining, based on a proportion range in which the proportion is located, a first AI network model corresponding to the first target layer, wherein the first target layer is any layer in layers reported by the terminal, and the second target layers are all layers corresponding to the terminal or all layers reported by the terminal; wherein
different proportion ranges correspond to different first AI network models, and the target parameter comprises any one of the following: an eigenvalue, a channel quality indicator (CQI), or a channel capacity.

4. The method according to claim 1, wherein first AI network models corresponding to all layers are different, and an input of a target first AI network model comprises channel information of a third target layer; wherein
layers corresponding to the terminal are sorted based on a target parameter, the third target layer is any one of the sorted layers corresponding to the terminal, the target first AI network model is a first AI network model corresponding to the third target layer, and the target parameter comprises any one of the following: an eigenvalue, a CQI, or a channel capacity.

5. The method according to claim 4, wherein the third target layer is any one of the sorted layers corresponding to the terminal except the first layer, and an input of the target first AI network model further comprises any one of the following:
an output of a first AI network model corresponding to a previous layer of the third target layer;
an output of a first AI network model corresponding to the first layer;
outputs of first AI network models respectively corresponding to all layers before the third target layer;
channel information corresponding to the previous layer of the third target layer; or
channel information respectively corresponding to all layers before the third target layer.

6. The method according to claim 1, wherein the inputting, by a terminal, channel information of each layer into a corresponding first AI network model for processing comprises:
inputting, by the terminal, the channel information of each layer into the corresponding first AI network model for processing after preprocessing the channel information of each layer.

7. The method according to claim 6, wherein the inputting, by the terminal, the channel information of each layer into the corresponding first AI network model for processing after preprocessing the channel information of each layer comprises any one of the following:
inputting, by the terminal, the channel information of each layer into the corresponding first AI network model after preprocessing the channel information of each layer by using a second AI network model; or
after preprocessing channel information of a target layer by using a target second AI network model, inputting, by the terminal, an output of the target second AI network model into a first AI network model corresponding to the target layer, wherein the target layer is any layer corresponding to the terminal, and each layer corresponds to one target second AI network model.

8. The method according to claim 1, wherein the reporting, by the terminal, the channel feature information corresponding to each layer to a network side device comprises:
post-processing, by the terminal, channel feature information corresponding to a target layer, and reporting the post-processed channel feature information to the network side device; wherein
the target layer is at least one layer corresponding to the terminal.

9. The method according to claim 8, wherein the post-processing, by the terminal, channel feature information corresponding to a target layer, and reporting the post-processed channel feature information to the network side device comprises:
post-processing, by the terminal, the channel feature information corresponding to the target layer to obtain channel feature information of a target length, wherein the target length is less than a length of the channel feature information that is not post-processed; and
reporting, by the terminal, the target length and the channel feature information of the target length to the network side device.

10. The method according to claim 8, wherein the target length is comprised in a first part of channel state information (CSI) in a case that the channel feature information is reported by using the CSI.

11. The method according to claim 1, wherein in a case that the channel feature information is reported by using the CSI, the reporting, by the terminal, the channel feature information corresponding to each layer to a network side device comprises any one of the following:
in a case that the layers corresponding to the terminal are sorted based on the target parameter, reporting, by the terminal, the channel feature information corresponding to the first layer to the network side device by using the first part of the CSI, and reporting channel feature information corresponding to other layers except the first layer by using a second part of the CSI, wherein the target parameter comprises any one of the following: an eigenvalue, a CQI, or a channel capacity;
reporting, by the terminal, the channel feature information corresponding to each layer to the network side device by using the second part of the CSI; or
reporting, by the terminal, the channel feature information corresponding to each layer to the network side device by using a corresponding block in the second part of the CSI, wherein one layer corresponds to one block.

12. The method according to claim 1, wherein the reporting, by the terminal, the channel feature information corresponding to each layer to a network side device comprises:
reporting, by the terminal, the channel feature information corresponding to each layer to the network side device, and discarding the channel feature information in a reverse order of an order of the layers.

13. The method according to claim 1, wherein the method further comprises:
determining, by the terminal, the rank of the channel based on a CSI reference signal channel estimation result; and
the reporting, by the terminal, the channel feature information corresponding to each layer to a network side device comprises:
reporting, by the terminal, a rank indicator (RI) and the channel feature information corresponding to each layer to the network side device.

14. The method according to claim 1, wherein the channel information is precoding information.

15. A channel feature information transmission method, comprising:
receiving, by a network side device, channel feature information corresponding to each layer that is reported by a terminal; wherein
one layer of the terminal corresponds to one first AI network model, and the first AI network model is used to process channel information of a layer that is input by the terminal and output the channel feature information.

16. The method according to claim 15, wherein first AI network models corresponding to all layers are different, and lengths of channel feature information output by the first AI network models gradually decrease in a sequence of the layers.

17. The method according to claim 15, wherein in a case that the channel feature information is reported by using CSI, the receiving, by a network side device, channel feature information corresponding to each layer that is reported by a terminal comprises any one of the following:
in a case that the layers corresponding to the terminal are sorted based on a target parameter, receiving, by the network side device, channel feature information corresponding to the first layer that is reported by the terminal by using a first part of the CSI, and channel feature information corresponding to other layers except the first layer that is reported by using a second part of the CSI, wherein the target parameter comprises any one of the following: an eigenvalue, a CQI, or a channel capacity;
receiving, by the network side device, channel feature information corresponding to each layer that is reported by the terminal by using the second part of the CSI; or
receiving, by the network side device, channel feature information corresponding to each layer that is reported by the terminal by using a corresponding block in the second part of the CSI, wherein one layer corresponds to one block.

18. The method according to claim 15, wherein the receiving, by a network side device, channel feature information corresponding to each layer that is reported by a terminal comprises:
receiving, by the network side device, a rank indicator (RI) and the channel feature information corresponding to each layer that are reported by the terminal.

19. A terminal, comprising a processor and a memory, wherein the memory stores a program or an instruction that can be run on the processor, wherein the program or the instruction, when executed by the processor, causes the terminal to perform:
inputting channel information of each layer into a corresponding first artificial intelligence (AI) network model for processing, and obtaining channel feature information output by the first AI network model, wherein one layer corresponds to one first AI network model; and
reporting the channel feature information corresponding to each layer to a network side device.

20. A network side device, comprising a processor and a memory, wherein the memory stores a program or an instruction that can be run on the processor, and when the program or the instruction is executed by the processor, the steps of the channel feature information transmission method according to claim 15 are implemented.
